(19) United States
(12) Patent Application Publication
(10) Pub. No.: US 2009/0073217 A1
(43) Pub. Date: Mar. 19, 2009

(54) Method of removing air from an ink jet device, and ink jet device

(75) Inventor: Takeshi Yaneda, Mie (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 11/918,506

(22) PCT Filed: Apr. 11, 2006
(86) PCT No.: PCT/JP2006/307604

§ 371 Date: Oct. 12, 2007

(30) Foreign Application Priority Data
Apr. 12, 2005 (JP) 2005-14316

(51) Int. Cl. B41J 2/165

(52) U.S. Cl. 347/30

(57) ABSTRACT

An ink jet device (100) includes: an ink jet head (1) having a nozzle opening for ejecting ink; a capping element (2) removably fitted on the ink jet head (1) so as to cover a surface defining the nozzle opening; a filter chamber (5) for passing ink fed thereto from an ink tank (9) to the ink jet head (1) through a filter; a first negative pressure generator (7) connected to the capping element (2) for providing a negative pressure inside the capping element (2) in a position fitted on the ink jet head (1) to discharge air present inside the capping element (2); and a second negative pressure generator (8) connected to an exhaust port (55) for providing a negative pressure inside the filter chamber (5) to discharge air present inside the filter chamber (5) from the exhaust port (55). The second negative pressure generator (8) provides the negative pressure inside the filter chamber (5) while the first negative pressure generator (7) is providing the negative pressure inside the capping element (2).

### TECHNICAL FIELD

The present invention relates to a method of removing air from an ink jet device configured to eject ink from nozzle openings, as well as an ink jet device.

### BACKGROUND ART

Ink jet devices have been widely used because they are capable of easily forming a vivid color image on a recording medium such as a recording sheet by ejecting ink from an ink jet head and require low costs including low running cost. Driving systems for such driving ink eject heads include: a thermal jet type driving system configured to jet ink by utilizing a membrane boiling phenomenon caused by heat generated by a heater; and a piezoelectric type driving system configured to utilize deflection mode deformation and shear mode deformation of a piezoelectric material.

Because ink to be ejected contains foreign matter and the like, such foreign matter is responsible for inconveniences including wrinkling of dots just put on a recording medium and failure to eject ink due to a nozzle opening clogged.

In order to remove such foreign matter, a conventional ink jet device feeds ink from an ink tank containing ink to the ink jet head through a filter chamber. The filter chamber is provided with a filter positioned to partition the internal space thereof into two regions. Such filters include nonwoven fabric type filters each comprising resin fibers or metal fibers, sintered type filters each formed from sintered resin or metal, and metal sheet type filters each formed with small perforations by etching or the like. The internal regions of the filter chamber partitioned with the filter are connected to respective of the ink tank and the ink jet head through respective ink feed tubes. The filter chamber is formed from a high solvent-resistant resin such as polypropylene or Teflon (registered trademark) or a high solvent-resistant metal such as aluminum or SUS so as to be unaffected by a solvent or the like.

When the ink jet head is driven to eject (consume) ink, ink is fed from the ink tank to the ink jet head through the filter chamber. At that time, ink passes through the filter located in the filter chamber before reaching the ink jet head. The filter removes the foreign matter contained in ink passing therethrough.

Besides foreign matter, multiple air bubbles are introduced into the filter chamber together with ink. Such air bubbles, if left as they are, flow into the ink jet head together with ink to cause some nozzle opening to become incapable of ejecting ink.

In order to prevent such air bubbles from flowing into the ink jet head, some conventional ink jet devices have an arrangement as shown in FIG. 5, wherein a filter chamber 105 is formed with a filter chamber inlet port 154 allowing ink fed from the ink tank to flow into the filter chamber 105 and a filter chamber outlet port 154 allowing ink to flow out of the filter chamber 105 toward the ink jet head, the inlet port 153 being positioned vertically higher than the filter chamber outlet port 154 (see patent document 1 for example).

With the arrangement of patent document 1, even when air bubbles 31 flow from a region X into a region Y in the filter chamber 105 through a filter 151, the air bubbles 31 ascend by buoyancy and hence are prevented from flowing from the filter chamber outlet port 154 into the ink jet head together with ink.

However, air bubbles 31 continue to accumulate in the region Y of the filter chamber 105 with continuous use of the ink jet device or by a like factor. When accumulated air bubbles 31 come near the level at which the filter chamber outlet port 154 is positioned, air bubbles 31 sometimes flow from the outlet port 154 into the ink jet head together with ink. As a result, some nozzle opening becomes incapable of ejecting ink.

Such an idea is conceivable as to reduce the amount of air 31 by the use of deaerating ink which is capable of dissolving air 31 therein. However, the dissolvable amount of air 31 is limited. In addition, since the amount of ink dissolved in ink increases as air 31 dissolves in ink increasingly, such a problem as cavitation occurs to affect the ejecting stability greatly.

The ink jet head of an ink jet device is subjected to maintenance for maintaining the ejecting performance thereof and the like. Such maintenance includes applying the ink jet head with a negative pressure of not higher than −5 kPa for example to suck ink out of the nozzle openings thereby removing foreign matter and the like deposited around each nozzle opening. At that time, ink flows through the passage extending from the ink tank to the ink jet head more strongly than in the ink ejecting operation.

For this reason, during the above-described maintenance in which a negative pressure is applied to the ink jet head to cause a strong flow of ink, it is possible that air bubbles 31, even located at a high level, pass through the filter chamber outlet port 154 together with ink, though air bubbles 31 in the region Y of the filter chamber 105 do not pass through the outlet port 154 during the ink ejecting operation causing ink to flow gently.

Therefore, inclusion of air 31 into the chamber 105 has to be prevented for ink to be ejected stably.

In order to discharge air accumulated in the filter chamber, some conventional ink jet device has an arrangement wherein the filter chamber has an exhaust port connected to a negative pressure generator configured to provide a negative pressure inside the filter chamber thereby discharging air through the exhaust port together with ink.

[Patent document 1]: Japanese Patent Laid-Open Publication No. SHO 62-257857

### DISCLOSURE OF INVENTION

### Problem to be Solved by Invention

With the above-described ink jet device having the exhaust port, however, when a negative pressure is applied to the inside of the filter chamber, it is possible that ink flows back from the ink jet head toward the filter chamber thereby causing air to be sucked into nozzle openings. As a result, air thus sucked in makes some nozzle opening incapable of jetting ink.

A lower limit value P1 of a negative pressure to be applied to the inside of the filter chamber so as not to suck air into the nozzle openings is determined from the formula: P1=−4σ/D, where D represents the nozzle diameter of a nozzle opening and σ represents the surface tension of ink. For example, in the case of an ink jet device including an ink jet head having nozzle openings each having a nozzle diameter of 22 μm and employing an ink having a surface tension of 30×10⁻³ N/m, we have P1≈−5.45 kPa. Accordingly, when a negative pressure of not higher than −5.5 kPa is provided in the filter chamber of the ink jet device having the above-described arrangement, air is sucked into the nozzle openings.

An object of the present invention is to provide: a method of removing air from an ink jet device which is capable of completely discharging air present inside the filter chamber from the exhaust port while preventing air from being sucked into nozzle openings, thereby maintaining the ejecting performance of the ink jet head for a long period of time; and an ink jet device applying the same method.

### Means for Solving Problem

In order to solve the foregoing problems, the present invention provides the following arrangements:

(1) A method of removing air from an ink jet device including an ink jet head having an nozzle opening for ejecting ink fed from an ink tank, a capping element removably fitted on the ink jet head so as to cover a surface defining the nozzle opening, and a filter chamber for passing ink fed thereto from the ink tank through an ink feed port to the ink jet head through a filter, the filter chamber having an exhaust port for discharging air present inside the filter chamber, the method comprising:

a first air discharge step of providing a negative pressure inside the capping element in a position fitted on the ink jet head and discharging air present inside the capping element; and

a second air discharge step, which is started during performance of the first air discharge step, of providing a negative pressure inside the filter chamber and discharging air present inside the filter chamber from the exhaust port.

According to this arrangement, the second air discharge step of providing a negative pressure inside the filter chamber is started during performance of the first air discharge step of providing a negative pressure inside the capping element. Accordingly, the negative pressure is provided inside the filter chamber, while the surface defining the nozzle opening, which is inside the capping element, is under a negative-pressure condition. For this reason, ink present in the ink jet head does not flow back into the filter chamber during discharge of air together with ink present inside the filter chamber by the negative pressure, with the result that air is prevented from being sucked into the nozzle opening.

(2) The first air discharge step is ended after the second air discharge step has been ended.

According to this arrangement, the first air discharge step of providing a negative pressure inside the capping element is ended after the second air discharge step of providing a negative pressure inside the filter chamber has been ended. Accordingly, the inside of the capping element is constantly in a negative-pressure condition during discharge of air present inside the filter chamber, thus preventing air from being sucked into the nozzle opening.

Since the inside of the capping element is still in the negative-pressure condition even after the second air discharge step has been ended, ink is sucked out of the nozzle opening to cause a flow of ink to occur from the ink tank to the ink jet head. At that time, the flow velocity of ink is higher than that in the second air discharge step. Therefore, air mixed in ink on a passage extending from an inside region of the filter chamber, the inside region being located on the ink jet head side to the ink jet head can be easily discharged outside the ink jet head together with ink.

(3) The second air discharge step is started after the first air discharge step has been started.

According to this arrangement, the second air discharge step of providing a negative pressure inside the filter chamber is started after the first air discharge step of providing a negative pressure inside the capping element has been started. In cases where the first and second air discharge steps are started at the same time, it is possible that the internal pressure of the filter chamber becomes negative earlier than the internal pressure of the capping element does, so that ink momentarily flows back from the ink jet head toward the filter chamber to cause air to be sucked into the nozzle opening. However, the subject arrangement, in which a negative pressure is provided inside the filter chamber after a negative pressure has been provided inside the capping element, can prevent air from being sucked into the nozzle opening.

(4) During at least one of performance of the first air discharge step and the second air discharge step, a value A of the negative pressure inside the capping element and a value B of the negative pressure inside the filter chamber satisfy the expression of relation:
|A|≧|B|−4σ/D, where σ represents a surface tension of ink and D represents a nozzle diameter of the nozzle opening.

According to this arrangement, during performance of any air discharge step, the absolute value |A| of the negative pressure inside the capping element is constantly not less than the absolute value |B| of the filter chamber plus a lower limit value of a negative pressure which does not cause air to be sucked into the nozzle opening. That is, the head difference between the negative pressure inside the capping element and the negative pressure inside the filter chamber is not less than the lower limit value of the negative pressure which does not cause air to be sucked into the nozzle opening. Accordingly, ink does not flow back from the ink jet head into the filter chamber and, hence, air can be prevented from being sucked into the nozzle opening.

(5) The second air discharge step is performed at least once after the ink jet head has been first filled with ink.

According to this arrangement, after the ink jet head has been first filled with ink, negative pressures are provided inside respective of the capping element and the filter chamber to discharge air present inside the filter chamber. When the ink jet head has been first filled with ink, a larger amount of air than usual is contained in each of the ink jet head and the filter chamber due to the ink filling operation and the like. The subject arrangement makes it possible to discharge air before the device is used and hence can eliminate the need to perform maintenance before use.

(6) The second air discharge step is performed plural times intermittently.

According to this arrangement, the second air discharge step of providing a negative pressure inside the filter chamber is performed plural times intermittently. Air present inside the filter chamber is discharged together with a flow of ink being discharged outside by the negative pressure. In this case, some air bubbles attached to the filter and to the inner wall surface of the filter chamber fail to be discharged without separating therefrom. Even when a constant value of negative pressure is applied to the inside of the filter chamber, the flow velocity of ink reaches a maximum immediately after the application of the negative pressure. When the second air discharge step is performed plural times intermittently, the flow velocity of ink reaches a maximum plural times to cause air bubbles attached to the wall surface and the like to be separated therefrom by flows of ink and then discharged together with ink.

(7) The method further comprises a pressurizing step of providing a positive pressure inside the ink tank during performance of the second air discharge step.

According to this arrangement, the pressurizing step of providing a positive pressure inside the ink tank is performed during performance of the second air discharge step of providing a negative pressure inside the filter chamber. In a typical ink jet device, the head difference between the ink tank 9 and the ink jet head 1 is established so that the internal pressure of the ink tank is negative relative to that of the ink jet head. The pressurizing step makes the internal pressure of the ink tank positive to prevent ink from flowing back from the ink jet head toward the ink tank, thereby lowering the possibility of suction of air into the nozzle opening.

(8) The second air discharge step is performed m (1≦m) times during performance of the first air discharge step and, succeedingly, performed n (1≦n) times irrespective of whether or not the first air discharge step is performed, wherein a value Ai of the negative pressure inside the capping element and a value Bi of the negative pressure inside the filter chamber, which are obtained by the ith (i=1, 2, 3, . . . , m+n) performance of the second air discharge step, satisfy the expression of relation: min(|Aj−Bj|)>max(|Ak−Bk|), where 1≦j≦m, and m+1≦k≦m+n.

According to this arrangement, the second air discharge step is performed at least m times during performance of the second air discharge step. Thereafter, succeedingly, the second air discharge step is performed n times. The first and second air discharge steps are performed so that the maximum value {max(|Ak−Bk|)} of the head difference between the value Ai of the negative pressure inside the capping element and the value Bi of the negative pressure inside the filter chamber, which is obtained during the performance of the n-times second air discharge step, is smaller than the minimum value {min(|Aj−Bj|)} of the head difference between the value Ai of the negative pressure inside the capping element and the value Bi of the negative pressure inside the filter chamber, which is obtained during the performance of the m-times second air discharge step. That is, the head difference obtained during the m-times second air discharge step is always larger than that obtained during the n-times second air discharge step.

The flow velocity of ink within the filter chamber during the performance of the m-times second air discharge step which provides a larger head difference is higher than that obtained during the performance of the n-times second air discharge step. For this reason, air bubbles attached to the inner wall surface of the filter chamber and the like can be separated therefrom easily by the m-times second air discharge step. The flow velocity within the filter chamber during the performance of the subsequent n-times second air discharge step is lower than that obtained during the performance of the m-times second air discharge step. However, since the attachment of air bubbles has been resolved by the m-times second air discharge step, air can be readily discharged together with ink by the n-times second air discharge step.

Since the head difference obtained during the performance of the n-times second air discharge step is smaller than that obtained during the performance of the m-times second air discharge step, the amount of ink discharged by the n-times second air discharge step is smaller than by the m-times second air discharge step. Therefore, the total amount of ink discharged is smaller than in the case where the m-times second air discharge step, which provides a larger head difference, is performed m+n times.

Further, the n-times second air discharge step is performed even when the first air discharge step is not performed. This is because the head difference is small in the n-times second air discharge step and, therefore, air is not sucked into the nozzle opening by the negative pressure inside the filter chamber even when the first air discharge step is not performed.

(9) The method further comprises a cleaning step of ending the first air discharge step after the second air discharge step has been performed m times and then removing ink attached to the surface defining the nozzle opening, wherein the second air discharge step is performed n times after completion of the cleaning step.

According to this arrangement, the surface defining the nozzle opening is subjected to cleaning after the m-times second air discharge step and before the n-times second air discharge step. Since a portion of ink is attached to the surface defining the nozzle opening after the first air discharge step has been ended, the portion of ink that is attached to that surface may drag a portion of ink that is present inside the ink jet head at a location adjacent the nozzle opening to cause the latter portion of ink to flow out of the nozzle opening during the period between one performance and the subsequent performance of the n-times second air discharge step in the case where the cleaning step is not performed. In reaction thereto, air may be sucked into the nozzle opening during the performance of the n-times second air discharge step. The cleaning step, which removes the portion of ink attached to the surface defining the nozzle opening, can prevent air from being sucked into the nozzle opening.

(10) An ink jet device comprising:

an ink jet head having a nozzle opening for ejecting ink fed thereto from an ink tank;

a capping element removably fitted on the ink jet head so as to cover a surface defining the nozzle opening;

a filter chamber for passing ink fed thereto from the ink tank through an ink feed port to the ink jet head through a filter, the filter chamber having an exhaust port for discharging air present inside the filter chamber;

a first negative pressure generator connected to the capping element for providing a negative pressure inside the capping element in a position fitted on the ink jet head and discharging air present inside the capping element; and

a second negative pressure generator connected to the exhaust port for providing a negative pressure inside the filter chamber and discharging air present inside the filter chamber from the exhaust port,

the second negative pressure generator provides the negative pressure inside the filter chamber through the exhaust port while the first negative pressure generator is providing the negative pressure inside the capping element.

According to this arrangement, the second negative pressure generator provides the negative pressure inside the filter chamber while the first negative pressure generator is providing the negative pressure inside the capping element, thereby discharging air from the exhaust port together with ink. Accordingly, the negative pressure is provided inside the filter chamber, while the surface defining the nozzle opening, which is inside the capping element, is under a negative-pressure condition. For this reason, ink present in the ink jet head does not flow back into the filter chamber during discharge of air and ink present inside the filter chamber by the negative pressure, with the result that air is prevented from being sucked into the nozzle opening.

(11) The filter chamber is positioned vertically higher than the ink jet head.

According to this arrangement, the filter chamber is positioned vertically higher than the ink jet head. Therefore, even when air is present in the ink jet head, air ascends into the filter chamber by buoyancy.

(12) The first negative pressure generator and the second negative pressure generator are the same negative pressure generator.

This arrangement employs a single negative pressure generator as the first and second negative pressure generators.

(13) The exhaust port has a smaller inside diameter than that of the ink feed port.

According to this arrangement, the exhaust port of the filter chamber has a smaller inside diameter than that of the ink feed port connected to the ink tank. Accordingly, the outflow resistance to ink flowing out of the filter chamber through the exhaust port is higher than the inflow resistance to ink being fed from the ink tank into the filter chamber. For this reason, during discharge of air, the feed rate of ink being fed from the ink tank is higher than the discharge rate of ink outgoing from the filter chamber through the exhaust port and, therefore, it is possible to prevent air bubbles from being produced at some midpoint on the passage of ink.

(14) The ink tank and the ink feed port are interconnected through an ink feed tube, while the second negative pressure generator and the exhaust port are interconnected through an exhaust tube, the exhaust tube having a smaller bore than that of the ink feed tube.

According to this arrangement, the exhaust tube interconnecting the second negative pressure generator and the exhaust port of the filter chamber has a smaller bore than that of the ink feed tube interconnecting the ink tank and the ink feed port of the filter chamber. Therefore, the outflow resistance to ink flowing out of the filter chamber through the exhaust port is higher than the inflow resistance to ink being fed from the ink tank into the filter chamber. For this reason, during discharge of air, the feed rate of ink being fed from the ink tank is higher than the discharge rate of ink outgoing from the filter chamber through the exhaust port and, therefore, it is possible to prevent air bubbles from being generated at some midpoint on the passage of ink.

### ADVANTAGE OF INVENTION

The present invention offers the following advantages:

(1) By starting the second air discharge step of providing a negative pressure inside the filter chamber during the performance of the first air discharge step of providing a negative pressure inside the capping element, it is possible to discharge air present inside the filter chamber effectively while preventing air from being sucked into the nozzle opening. Thus, the ink ejecting performance of the device can be maintained for a long period of time.

Since it is possible to prevent air from being sucked into the nozzle opening, the filter chamber can be provided therein with a stronger negative pressure than in a conventional ink jet device, whereby air can be discharged out of the filter chamber more completely.

(2) By ending the first air discharge step after the second air discharge step has been ended, it is possible to prevent air from being sucked into the nozzle opening. Also, since air present in the passage extending from an inside region of the filter chamber, the inside region being located on the ink jet head side, to the ink jet head can discharged, air present in the filter chamber and in the ink jet head can be discharged more effectively.
(3) By starting the second air discharge step after the first air discharge step has been started, it is possible to prevent air from being sucked into the nozzle opening more completely.
(4) By setting the absolute value |A| of the negative pressure inside the capping element not less than the absolute value |B| of the filter chamber plus a lower limit value of a negative pressure which does not cause air to be sucked into the nozzle opening during the first or second air discharge step, it is possible to prevent air from being sucked into the nozzle opening more completely.
(5) By performing the second air discharge step at least once after the ink jet head has been first filled with ink, air can be discharged before the ink jet device is used, which is very useful for the user.
(6) By performing the second air discharge step of providing a negative pressure inside the filter chamber plural times intermittently, air present inside the filter chamber can be discharged effectively.
(7) By performing the pressurizing step of providing a positive pressure inside the ink tank during the performance of the second air discharge step of providing a negative pressure inside the filter chamber, it is possible to prevent ink from flowing back from the ink jet head toward the ink tank, thereby lowering the possibility of suction of air into the nozzle opening. Thus, ink can be ejected stably.
(8) By performing the second air discharge step at least m times during the performance of the first air discharge step and, succeedingly, n times, it is possible to discharge air out of the filter chamber effectively while preventing air from being sucked into the nozzle opening, as well as to reduce the amount of ink to be discharged (consumed) out of the filter chamber.
(9) By cleaning the surface defining the nozzle opening after the m-times second air discharge step and before the n-times second air discharge step, it is possible to prevent air from being sucked into the nozzle opening effectively during the performance of the n-times second air discharge step.
(10) By providing the negative pressure inside the filter chamber while the first negative pressure generator is providing a negative pressure inside the capping element capping the nozzle opening, it is possible to discharge air present inside the filter chamber effectively while preventing air from being sucked into the nozzle opening. Thus, the ink ejecting performance of the ink jet device can be maintained for a long period of time.

Also, since it is possible to prevent air from being sucked into the nozzle opening, the filter chamber can be provided therein with a stronger negative pressure than in a conventional ink jet device, whereby air can be discharged out of the filter chamber more completely.

(11) By positioning the filter chamber vertically higher than the ink jet head, it is possible to prevent air from staying within the ink jet head.
(12) By using a common negative pressure generator serving as the first negative pressure generator and the second negative pressure generator both, it is possible to suppress an increase in cost.
(13) By forming the exhaust port having a smaller inside diameter than that of the ink feed port, it is possible to prevent air bubbles from being generated at some midpoint on the passage of ink during air discharge.
(14) By forming the exhaust tube having a smaller bore than that of the ink feed tube, it is possible to prevent air bubbles from being generated at some midpoint on the passage of ink during air discharge.

### BRIEF DESCRIPTION OF DRAWINGS

FIG. 1 is an explanatory view illustrating the configuration of a part of an ink jet device according to an embodiment of the present invention.

FIG. 2 is a sectional view showing the structure of a filter chamber included in the ink jet device.

FIG. 3 is an explanatory view illustrating the configuration of a part of the ink jet device.

FIG. 4 is a sectional view showing the structure of an ink tank included in the ink jet device.

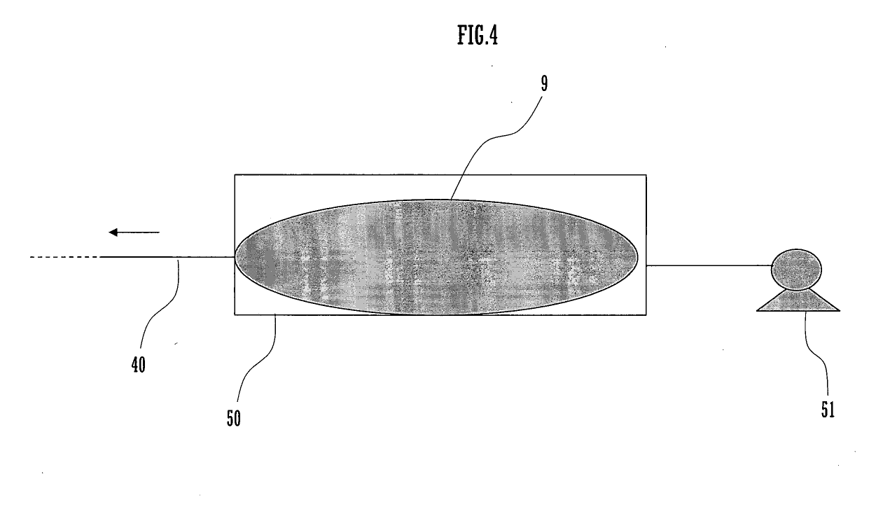

FIG. 5 is a sectional view showing the structure of a conventional filter chamber.

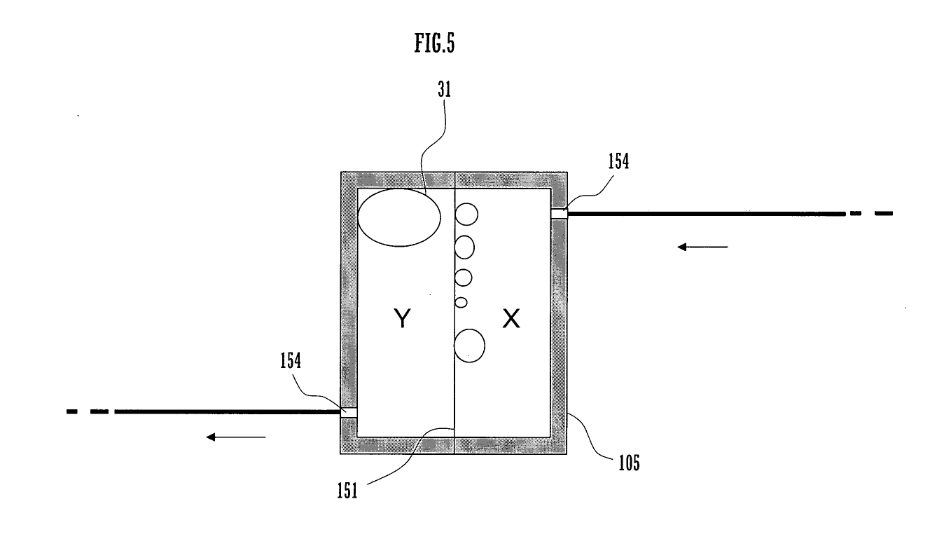

### DESCRIPTION OF REFERENCE CHARACTERS

1 . . . ink jet head
2 . . . capping element
5 . . . filter chamber
7 . . . first negative pressure generator
8 . . . second negative pressure generator
9 . . . ink tank
31 . . . air
51 . . . filter chamber inlet port
55 . . . exhaust port

### BEST MODE FOR CARRYING OUT THE INVENTION

Hereinafter, an ink jet device according to the best mode for carrying out the present invention will be described in detail with reference to the drawings.

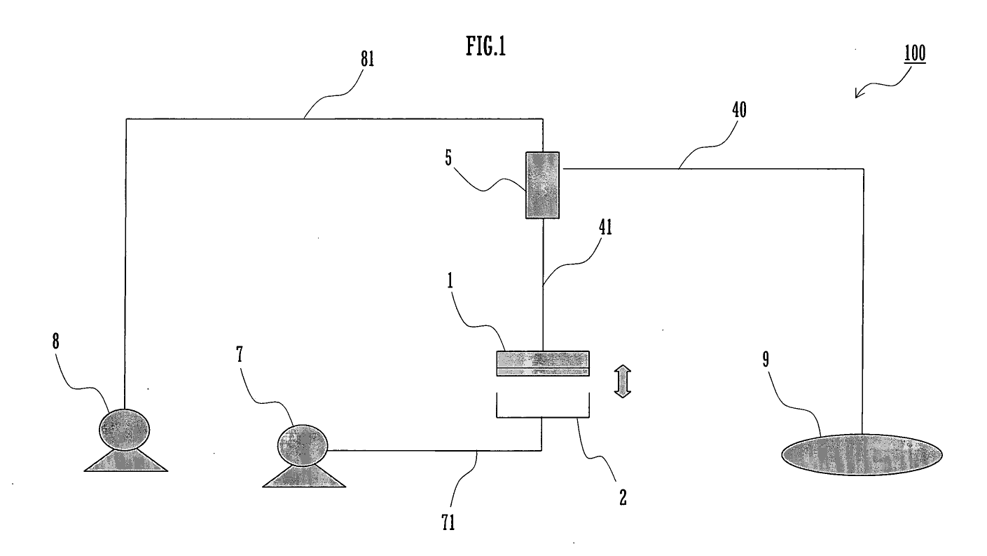

FIG. 1 is an explanatory view illustrating the configuration of a part of an ink jet device 100 according to the present invention. Ink jet device 100 includes an ink jet head 1, a capping element 2, a filter chamber 5, a first negative pressure generator 7, a second negative pressure generator 8, an ink tank 9, and other components.

The ink jet head 1 has non-illustrated nozzle openings and is configured to eject ink fed from the ink tank 9 against a recording medium such as a recording sheet.

According to the present embodiment, the nozzle openings of the ink jet head 1 each have a nozzle diameter of 22 μm, and ink employed has a surface tension of 30×10⁻³ N/m. The capping element 2 is removably fitted on the ink jet head 1 so as to cover a surface defining the nozzle openings (hereinafter will be referred to as “nozzle surface”). The capping element 2 is fitted on the ink jet head 1 when the ink jet head 1 is not used to eject ink, in order to prevent ink from sticking to around each nozzle opening.

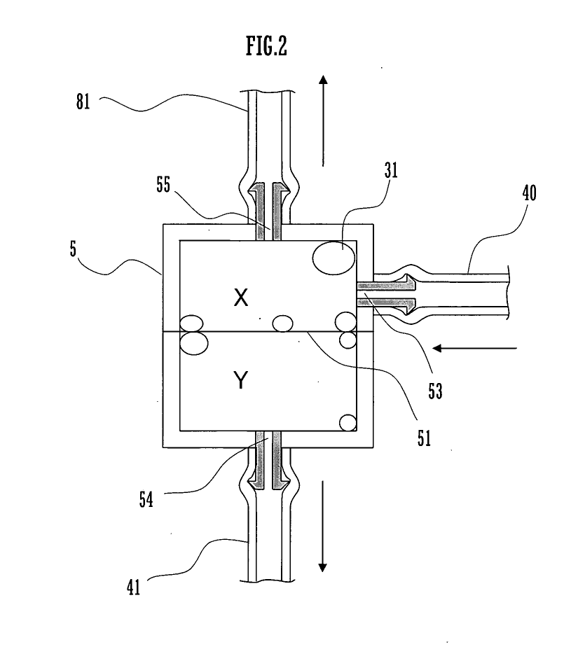

As shown in FIG. 2, the filter chamber 5 includes a filter 51, a filter chamber inlet port 53 (equivalent to the ink feed port defined by the present invention), a filter chamber outlet port 54, an exhaust port 55, and the like. The filter chamber 5 removes foreign matter from ink and then feed ink to the ink jet head 1. The filter 51 is positioned to partition the internal space of the filter chamber 5 into two regions X and Y and filters out foreign matter from ink when ink passes from the region X to the region Y.

Examples of filter 51 include nonwoven fabric type filters each comprising resin fibers or metal fibers, sintered type filters each formed from sintered resin or metal, and metal sheet type filters each formed with small perforations by etching or the like.

The filter chamber inlet port 53 is connected to the ink tank 9 through an ink feed tube 40. The filter chamber outlet port 54 is connected to the ink jet head 1 through an ink feed tube 41. The exhaust port 55 is connected to the second negative pressure generator 8 through an exhaust tube 81 for discharging, together with ink, air 31 present inside the filter chamber 5.

The first negative pressure generator 7 is connected to the capping element 2 through an exhaust tube 71. The first negative pressure generator 7 provides a negative pressure inside the capping element 2 in a position fitted on the ink jet head 1 in order to discharge air 31 therefrom. The second negative pressure generator 8, which is connected to the exhaust port 55 as described above, provides a negative pressure inside the filter chamber 5 in order to discharge air 31 therefrom.

The ink tank 9 contains ink therein for feeding ink to the ink jet head 1. When the ink jet head 1 is driven to eject (consume) ink, ink is fed from the ink tank 9 to the ink jet head 1 through the filter chamber 5. The ink tank 9 maintains a head difference of approximately −0.5 kPa relative to the ink jet head 1. Accordingly, ink does not leak out of the nozzle openings and can be ejected stably.

As described earlier, there are various driving systems for driving the ink jet head 1, including the thermal jet type driving system, and the piezoelectric type driving system. In the present embodiment, any one of such driving systems may be employed for the ink jet head 1.

When the ink jet head 1 is left uncapped without performing the ejecting operation or left unoperated for a long period of time even if capped, the viscosity of ink forming a meniscus around each nozzle opening increases. For this reason, the ink jet head 1 is subjected to maintenance when a part of plural nozzle openings becomes incapable of ejecting ink. For example, when the user has pressed a non-illustrated head cleaning button, a non-illustrated control section causes the ink jet head 1 or the capping element 2 to move up and down so that the capping element 2 is fitted on the ink jet head 1 to cover the surface defining the nozzle openings. By doing this, the inside of the capping element 2 can be closed air-tightly. Thereafter, the first negative pressure generator 7 is driven for a fixed period of time to provide a negative pressure (about −40 kPa for example) inside the capping element 2. At that time, ink flows out of each nozzle opening until the negative pressure inside the capping element 2 rises to a value close to the atmospheric pressure. This flow of ink causes the meniscus of ink having an increased viscosity to be peeled off from around each nozzle opening and then discharged.

Thereafter, the ink jet head 1 is separated from the capping element 2 and then a non-illustrated wiper is driven to wipe the nozzle surface to remove ink attached to the nozzle surface. In this way, the ink jet head 1 can be recovered from the condition in which the ink jet head 1 is incapable of ejecting ink.

Such maintenance of the ink jet head 1 may be conducted automatically on a periodical basis, for example, at intervals of a predetermined number of operations of the ink jet head 1.

The filter chamber 5 is subjected to maintenance when air is present inside the filter chamber 5 due to replacement of the ink tank 9 or the like. For example, in response to a press of a non-illustrated air removal button by a user, the control section causes the capping element 2 to be fitted on the ink jet head 1.

Subsequently, the first and second negative pressure generators 7 and 8 are each driven for a fixed period of time to provide a negative pressure (having a value of not higher than −5 kPa, for example −40 kPa in the present embodiment) inside a respective one of the filter chamber 5 and the capping element 2. The resulting head difference between the ink tank 9 and the filter chamber 5 causes ink to flow from the ink tank 9 into the filter chamber 5 through the ink feed tube 40. On the other side, ink is discharged from the exhaust port 55.

Since ink flows from the ink tank 9 to the filter chamber 5, as shown in FIG. 2, and then to the exhaust port 55, air 31 that is present in the region X of the internal space of the filter chamber 5 can be discharged from the exhaust port 55 together with ink effectively.

For the purpose of confirming the above-described effect, the filter chamber 5 according to the present embodiment was formed from a transparent resin such as polycarbonate and then subjected to maintenance. As a result, it was visually confirmed that air bubbles 31 clinging to the wall surface of the region X and to the filter 51 in the filter chamber 5, which were considered difficult to be discharged, had been discharged completely.

As the negative pressure inside the filter chamber 5 lowers, the velocity of a flow of ink caused thereby increases and, hence, those air bubbles 31 which cling to the inner wall surface of the filter chamber 5 and to the filter 51 can be discharged easily. Thus, air 31 can be removed effectively.

When a negative pressure of, for example, about −5.5 kPa is applied to the inside of the filter chamber 5, air 31 can stay within the filter chamber 5 more easily than in the present embodiment (where a negative pressure of −40 kPa is applied to the inside of the filter chamber 5). A negative pressure of not higher than −5 kPa is sufficient as the internal pressure of the filter chamber 5 to discharge air 31 present inside the filter chamber 5 effectively.

In cases where a negative pressure of about −5 kPa is applied to the inside of the filter chamber 5, air 31 is not sucked into the nozzle openings even when the capping element 2 is not applied with a negative pressure. This is because a lower limit value P1 of a negative pressure which does not cause air 31 to be sucked into the nozzle openings is approximately 5.45 kPa in the case of the ink jet device according to the present embodiment (nozzle diameter: 22 μm, surface tension of ink: 30×10⁻³ N/m). The value P1 is determined from the formula: P1=−4σ/D, where σ represents the surface tension of ink and D represents the nozzle diameter of each nozzle opening.

When only the filter chamber 5 is applied therein with a negative pressure of not higher than −5.5 kPa, a meniscus of ink formed around each nozzle opening is broken, so that air 31 is sucked into the side of the ink jet head 1 through the nozzle openings. In view of such an inconvenience, the present embodiment is arranged such that the absolute value |A| of the negative pressure inside the capping element 2 is constantly kept not less than the absolute value |B| of the negative pressure inside the filter chamber 5 plus the lower limit value P1 of a negative pressure which does not cause air to be sucked into the nozzle openings during the operation of any one of the first and second negative pressure generators 7 and 8. Accordingly, ink does not flow back from the ink jet head 1 into the filter chamber 5 and, hence, air 31 can be prevented from being sucked into the inside of the ink jet head 1 through the nozzle openings. Stated otherwise, the head difference between the negative pressure inside the capping element 2 and the negative pressure inside the filter chamber 5 is kept not lower than the lower limit value P1 of the negative pressure which does not cause air to be sucked into the nozzle openings.

Since the lower limit value P1 of the negative pressure which does not cause air 31 to be sucked into the nozzle openings is determined from the formula: P1=−4σ/D, the expression of relation: |A|≧B|−4σ/D holds during the operation of the first negative pressure generator 7 or second negative pressure generator 8.

Also, the negative pressure provided inside the capping element 2 causes ink to flow from the region Y of the filter chamber 5 to the nozzle openings, thereby making it possible to discharge air 31 present in the region Y from the nozzle openings together with ink.

For the purpose of confirming the above-described effect, the filter chamber 5 according to the present embodiment was formed from the aforementioned transparent resin such as polycarbonate and then subjected to maintenance. As a result, it was visually confirmed that air bubbles 31 clinging to the wall surface of the region Y and to the filter 51 in the filter chamber 5, which were considered difficult to be discharged, had been discharged completely.

Thus, it is possible to prevent each of the nozzle openings from becoming incapable of ejecting ink due to inclusion of air 31 into the ink jet head 1, thereby to maintaining the ink ejecting performance of the ink jet head 1 for a long period of time.

Thereafter, the ink jet head 1 is separated from the capping element 2 and then the non-illustrated wiper is driven to wipe the nozzle surface to remove ink attached to the nozzle surface.

Such maintenance of the filter chamber 5 may be conducted automatically on a periodical basis, for example, at intervals of a predetermined number of operations of the ink jet head 1. Since inclusion of a large amount of air 31 into the filter chamber 6 occurs after the initial ink filling operation, maintenance of the filter chamber 5 may be conducted at least once after the initial ink filling operation. By so doing, air 31 can be discharged before the ink jet device 100 is used, which is very useful for the user.

The step of discharging air 31 present inside the capping element 2 by driving the first negative pressure generator 7 is equivalent to the first air discharge step defined by the present invention, while the step of discharging air 31 present inside the filter chamber 5 by driving the second negative pressure generator 8 is equivalent to the second air discharge step defined by the present invention.

The filter chamber 5 according to the present embodiment is positioned vertically higher than the ink jet head 1, as shown in FIG. 2. Accordingly, ink can flow from the filter chamber 5 to the ink jet head 1 easily, which makes it possible to prevent a back flow of ink. Therefore, it is possible to prevent air 31 from being sucked into the nozzle openings. Also, even when air 31 is present inside the ink jet head 1, air ascends into the filter chamber 5 by buoyancy. Thus, it is possible to prevent each nozzle opening from becoming incapable of ejecting ink due to air 31.

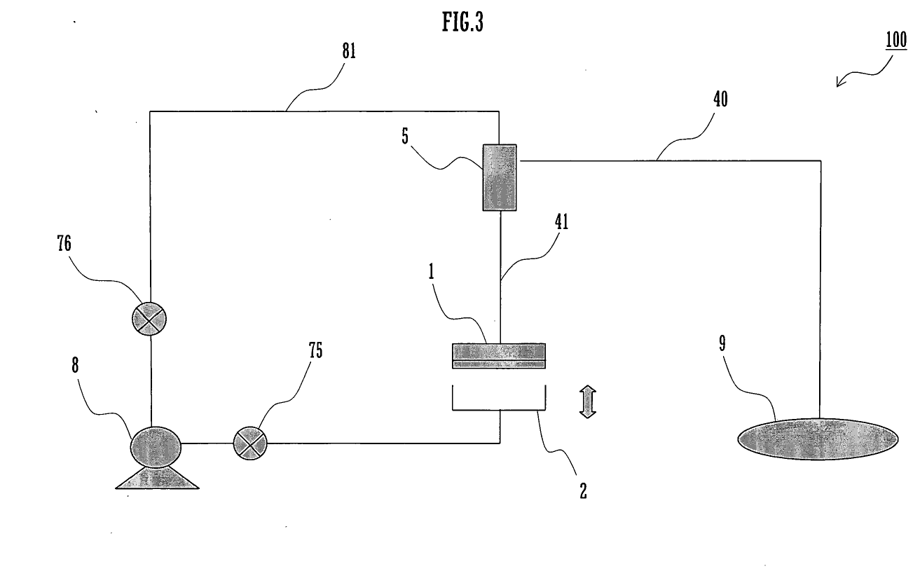

While the present embodiment is configured to provide negative pressures inside respective of the capping element 2 and the filter chamber 5 by means of the first and second negative pressure generators 7 and 8, there is no particular limitation to this configuration. For example, it is possible to employ a single common negative pressure generator 8 for providing negative pressures inside both of the capping element 2 and the filter chamber 5 as shown in FIG. 3. The negative pressure generator 8 is connected to the capping element 2 and to the filter chamber 5 via respective electromagnetic valves 75 and 76. Each of the electromagnetic valves 75 and 76 is turned on or off to select whether or not to provide a negative pressure inside a respective one of the capping element 2 and the filter chamber 5.

While the filter chamber 5 according to the present embodiment is positioned inside the ink jet device 100 in such a manner as shown in FIG. 2 and has the filter chamber inlet port 53, filter chamber outlet port 54 and exhaust port 55 formed at their respective locations shown in FIG. 2, there is no particular limitation to this structure. The filter chamber 5 may be formed with a plurality of such exhaust ports 55.

While the filter chamber 5 used in the present embodiment has a tubular shape with angular portions as shown in FIG. 2, there is no particular limitation to this structure. For example, the filter chamber 5 may have a streamlined internal shape for air 31 to be easily collected at a location adjacent the exhaust port 55 and to be discharged easily during the discharge operation and for air 31 to flow out from the filter chamber outlet port 54 toward the ink jet head 1 easily.

According to the present embodiment, the lower limit value P1 of the negative pressure which does not cause air 31 to be sucked into the nozzle openings is approximately 5.45 kPa, which is lower than the negative pressure (−5 kPa) applied to the inside of the filter chamber 5 for effectively removing air 31. For this reason, it is possible to remove air 31 effectively while preventing air 31 from being sucked into the nozzle openings by applying a negative pressure of −5 kPa only to the filter chamber 5 without application of a negative pressure to the capping element 2. Nevertheless, the arrangement for applying a negative pressure to the capping element 2 is very effective because that arrangement can reliably prevent air 31 from being sucked into the nozzle openings. In removing air 31 from the filter chamber 5 more effectively, the arrangement of concern is also very effective when the value of the negative pressure (−40 kPa) applied to the filter chamber 5 is lower than −5 kPa as in the present embodiment.

Further, the arrangement of concern is very effective for an ink jet device of the type in which the lower limit value P1 of the negative pressure which does not cause air 31 to be sucked into the nozzle openings is not lower than −5 kPa in effectively removing air 31 from the filter chamber 5 while preventing air 31 from being sucked into the nozzle openings.

### SECOND EMBODIMENT

The present embodiment has substantially the same arrangement as the foregoing embodiment except that the operation of the second negative pressure generator 8 ends earlier than that of the first negative pressure generator 7 during maintenance of the filter chamber 5. More specifically, the first and second negative pressure generators 7 and 8 are driven at the same time to discharge air 31 present inside the filter chamber 5 and then the operation of only the second negative pressure generator 8 is stopped. Thereafter, the operation of the first negative pressure generator 7 is stopped.

After the operation of the second negative pressure generator 8 has been ended, only the capping element 2 is provided therein with a negative pressure of not higher than −5 kPa. Accordingly, the flow velocity of ink flowing from the region Y of the filter chamber 5 to the ink jet head 1 is higher than in the condition where the filter chamber 5 is applied with the negative pressure by the second negative pressure generator 8. Therefore, air 31 present in the region Y of the filter chamber 5 can flow toward the ink jet head 1 together with ink more easily and hence can be discharged more effectively.

### THIRD EMBODIMENT

The present embodiment has substantially the same arrangement as the foregoing first embodiment except that the operation of the first negative pressure generator 7 is started earlier than that of the second negative pressure generator 8 in starting the maintenance of the filter chamber 5. More specifically, the second negative pressure generator 8 is driven after the first negative pressure generator 7 has started operating, and after lapse of a predetermined time period the first and second negative pressure generators 7 and 8 are stopped.

When the filter chamber 5 is applied with a negative pressure earlier than the capping element 2, ink may be caused to flow back from the ink jet head 1 toward the filter chamber 5 due to the difference in length between the exhaust tubes 71 and 81 or a like factor, though depending on the structure of the ink jet device 100. Accordingly, it is possible that air 31 is sucked into the nozzle openings. According to the present embodiment, however, the second negative pressure generator 8 is driven to provide the negative pressure inside the filter chamber 5 after the operation of the first negative pressure generator 7 has been previously started to make the internal pressure of the capping element 2 sufficiently negative, thereby making it possible to prevent air 31 from being sucked into the ink jet head 1 more effectively.

### FOURTH EMBODIMENT

The present embodiment has substantially the same arrangement as the foregoing first embodiment except that the second negative pressure generator 8 is driven intermittently for a fixed time period. As the head difference between the ink tank 9 and the filter chamber 5 increases, the flow velocity of ink becomes higher and, hence, the ability to discharge air 31 becomes higher. However, it is immediately after the occurrence of a water difference between the ink tank 9 and the filter chamber 5 that the flow velocity of ink reaches a maximum during the performance of the second negative pressure generator 8. For this reason, intermittent driving of the second negative pressure generator 8 makes it possible to discharge air 31 present in the filter chamber 5 effectively.

### FIFTH EMBODIMENT

The present embodiment has substantially the same arrangement as the fourth embodiment except that the second negative pressure generator 8 is driven intermittently in two stages. More specifically, in the first stage, the second negative pressure generator 8 is performed m (1≦m) times during an operation of the first negative pressure generator 7 for a fixed time period. According to the present embodiment, the first and second negative pressure generators 7 and 8 are driven so that the internal pressure of each of the capping element 2 and the filter chamber 5 assumes a value of not higher than −5 kPa in the first stage.

Subsequently, in the second stage, the second negative pressure generator 8 is performed n (1≦n) times under the condition that the operation of the first negative pressure generator 7 is stopped. According to the present embodiment, the second negative pressure generators 8 is driven so that the internal pressure of the filter chamber 5 assumes a value of higher than −5 kPa.

A value Ai of the negative pressure inside the capping element 2 and a value Bi of the negative pressure inside the filter chamber 5, which are obtained by the ith (i=1, 2, 3, . . . , m+n) performance of the intermittent operation of the second negative pressure generator 8, satisfy the expression of relation: min(|Aj−Bj|)>max(|Ak−Bk|), where 1≦j≦m and m+1≦k≦m+n.

That is, the maximum value {max(|Ak−Bk|)} of the head difference between the value Ai of the negative pressure inside the capping element 2 and the value Bi of the negative pressure inside the filter chamber 5, which is obtained during the second stage, is smaller than the minimum value {min(|Aj−Bj|)} of the head difference between the value Ai of the negative pressure inside the capping element 2 and the value Bi of the negative pressure inside the filter chamber 5, which is obtained during the first stage. Therefore, the head difference (|Ai−Bi|)} obtained during the first stage is always larger than that obtained during the second stage.

Because the flow velocity of ink within the filter chamber 5 in the second stage during which the second negative pressure generator 8 is driven n times is lower than that in the first stage during which the second negative pressure generator 8 is performed m times, air bubbles 31 attached to the wall surface of the filter chamber 5 and the like are difficult to separate therefrom. However, since the attachment of air bubbles 31 has already been resolved by the m-times driving of the second negative pressure generator 8, air 31 can be readily discharged together with ink.

Since the head difference obtained during the n-times intermittent driving is smaller than that obtained during the m-times intermittent driving, the amount of ink discharged during the n-times intermittent driving is smaller than that discharged during the m-times intermittent driving. Therefore, the total amount of ink discharged can be reduced as compared to the case where the m-times intermittent driving, which provides a larger head difference, is performed m+n times.

During the n-times intermittent driving of the second negative pressure generator 8, the first negative pressure generator 7 is not driven. This is because the head difference is small during the n-times intermittent driving and, therefore, air cannot be sucked into the nozzle openings by the negative pressure inside the filter chamber 5. In the second stage, the first negative pressure generator 8 may be driven.

While the first-stage intermittent driving and the second-stage intermittent driving of the second negative pressure generator 8 are performed successively according to the present embodiment, there is no particular limitation to this arrangement. A cleaning step of removing ink attached to the nozzle surface by driving a wiper to wipe the nozzle surface may be performed between the first and second stages.

If the cleaning step is not performed after the first-stage intermittent driving, a portion of ink that is attached to the nozzle surface drags a portion of ink that is present inside the ink jet head 1 at a location adjacent each nozzle opening to cause the latter portion of ink to flow out of the nozzle opening during the period between one performance and the subsequent performance of the n-times intermittent driving of the second negative pressure generator 8. In reaction thereto, it is possible that air is sucked into the nozzle openings during driving of the second negative pressure generator 8. The cleaning step, which removes the portion of ink attached to the nozzle surface, can effectively prevent air from being sucked into the nozzle openings.

### SIXTH EMBODIMENT

The present embodiment has substantially the same arrangement as the first embodiment except the feature that a pressure generator 51 connected to a pressure container 50 containing the ink tank 9 is driven to make the internal pressure of the ink tank 9 positive relative to that of the ink jet head 1. Note that in a typical ink jet device the head difference between the ink tank 9 and the ink jet head 1 is established so as to make the internal pressure of the ink tank 9 negative.

With this feature, it is possible to prevent ink from flowing back from the ink jet head 1 toward the ink tank 9, thereby to lower the possibility of suction of air 31 into the nozzle openings. Thus, the ink ejecting operation can be stabilized.

The step of driving the pressure generator 51 to make the internal pressures of the ink tank 9 and pressure container 50 positive is equivalent to the pressurizing step defined by the present invention.

### SEVENTH EMBODIMENT

The present embodiment has substantially the same arrangement as the first embodiment except that the exhaust port 55 has a smaller inside diameter than that of the filter chamber outlet port 51. Also, the exhaust tube 81 has a smaller bore than that of the ink feed tube 40.

According to this embodiment, the outflow resistance to ink flowing out of the filter chamber 5 through the exhaust port 55 is higher than the inflow resistance to ink flowing from the ink tank 9 into the filter chamber 5. For this reason, ink flows smoothly and, hence, it is possible to prevent air bubbles 31 from being generated at some midpoint on the passage of ink.

While any one of the foregoing embodiments has been described using the ink jet device 100 of the type configured to eject ink on a recording medium such as a recording sheet, there is no particular limitation to such an ink jet device. The present invention will offer the same advantage when the invention is applied to an ink jet device for use in manufacturing a color filter board for liquid crystal display devices or the like.

The foregoing embodiments are illustrative in all points and should not be construed to limit the present invention. The scope of the present invention is defined not by the foregoing embodiment but by the following claims. Further, the scope of the present invention is intended to include all modifications within the meanings and scopes of claims and equivalents.

1. A method of removing air from an ink jet device including an ink jet head having a nozzle opening for ejecting ink fed from an ink tank, a capping element removably fitted on the ink jet head so as to cover a surface defining the nozzle opening, and a filter chamber for passing ink fed thereto from the ink tank through an ink feed port to the ink jet head through a filter, the filter chamber having an exhaust port for discharging air present inside the filter chamber, the method comprising:
a first air discharge step of providing a negative pressure inside the capping element in a position fitted on the ink jet head and discharging air present inside the capping element; and
a second air discharge step, which is started during performance of the first air discharge step, of providing a negative pressure inside the filter chamber and discharging air present inside the filter chamber from the exhaust port.

2. The method according to claim 1, wherein the first air discharge step is ended after the second air discharge step has been ended.

3. The method according to claim 1, wherein the second air discharge step is started after the first air discharge step has been started.

4. The method according to claim 1, wherein during at least one of performance of the first air discharge step and the second air discharge step, a value A of the negative pressure inside the capping element and a value B of the negative pressure inside the filter chamber satisfy the expression of relation:

|A|≧|B|−4σ/D, where σ represents a surface tension of ink and D represents a nozzle diameter of the nozzle opening.

5. The method according to claim 1, wherein the second air discharge step is performed at least once after the ink jet head has been first filled with ink.

6. The method according to claim 1, wherein the second air discharge step is performed plural times intermittently.

7. The method according to claim 1, further comprising a pressurizing step of providing a positive pressure inside the ink tank during performance of the second air discharge step.

8. The method according to claim 6, wherein:
the second air discharge step is performed m (1≦m) times during performance of the first air discharge step and, succeedingly, performed n (1≦n) times irrespective of whether or not the first air discharge step is performed; and
a value Ai of the negative pressure inside the capping element and a value Bi of the negative pressure inside the filter chamber, which are obtained by the ith (i=1, 2, 3, . . . , m+n) performance of the second air discharge step, satisfy the expression of relation: min(|Aj−Bj|)>max(|Ak−Bk|), where 1≦j≦m, and m+1≦k≦m+n.

9. The method according to claim 8, further comprising a cleaning step of ending the first air discharge step after the second air discharge step has been performed m times and then removing ink attached to the surface defining the nozzle opening, wherein
the second air discharge step is performed n times after completion of the cleaning step.

10. An ink jet device comprising:
an ink jet head having a nozzle opening for jetting ink fed thereto from an ink tank;
a capping element removably fitted on the ink jet head so as to cover a surface defining the nozzle opening;
a filter chamber for passing ink fed thereto from the ink tank through an ink feed port to the ink jet head through a filter, the filter chamber having an exhaust port for discharging air present inside the filter chamber;
a first negative pressure generator connected to the capping element for providing a negative pressure inside the capping element in a position fitted on the ink jet head and discharging air present inside the capping element; and
a second negative pressure generator connected to the exhaust port for providing a negative pressure inside the filter chamber and discharging air present inside the filter chamber from the exhaust port,
the second negative pressure generator provides the negative pressure inside the filter chamber through the exhaust port while the first negative pressure generator is providing the negative pressure inside the capping element.

11. The ink jet device according to claim 10, wherein the filter chamber is positioned vertically higher than the ink jet head.

12. The ink jet device according to claim 10, wherein the first negative pressure generator and the second negative pressure generator are the same negative pressure generator.

13. The ink jet device according to claim 10, wherein the exhaust port has a smaller inside diameter than that of the ink feed port.

14. The ink jet device according to claim 10, wherein the ink tank and the ink feed port are interconnected through an ink feed tube, while the second negative pressure generator and the exhaust port interconnected through an exhaust tube,
the exhaust tube having a smaller bore than that of the ink feed tube.
